(19) United States
(12) Patent Application Publication
(10) Pub. No.: US 2026/0271848 A1
(43) Pub. Date: Sep. 17, 2026

(54) Plant Growing System

(71) Applicant: Keith Ford, Colorado Springs, CO (US)

(72) Inventor: Keith Ford, Colorado Springs, CO (US)

(21) Appl. No.: 19/078,461

(22) Filed: Mar. 13, 2025

(51) Int. Cl. A01G 31/02; A01G 7/04; A01G 31/00; A01G 31/06

(52) U.S. Cl. CPC A01G 31/065; A01G 31/008; A01G 31/024; A01G 31/06; A01G 7/045

(57) ABSTRACT

A plant growing system for growing plants hydroponically includes a reservoir, a shelf, and a fluid circulation mechanism. The shelf is mounted in a position spaced above the reservoir. The fluid circulation mechanism includes a delivery line extending from a cavity of the reservoir to the recess of the shelf, a pump mounted to the delivery line, and a return line extending from a recess of the shelf to the cavity of the reservoir. The pump is operable to urge a nutrient fluid from the cavity of the reservoir to the recess of the shelf via the delivery line, and the nutrient fluid is allowed to pass through the return line after circulating in the recess of the shelf. A framework is be provided for growing additional plants above the shelf. A processor operates components of the plant growing system to promote plant growth in various ways.

### (g) BACKGROUND OF THE INVENTION

### (1) Field of the Invention

The disclosure relates to plant growing systems and more particularly pertains to a new plant growing system for growing plants hydroponically.

### (2) Description of Related Art Including Information Disclosed under 37 CFR 1.97 and 1.98

Myriad hydroponic plant growing systems are disclosed by the prior art. However, the prior art fails to describe such a system comprising a reservoir, a shelf, a fluid circulation system, a plurality of light sources, and plant rafts are provided, wherein the fluid circulation system is operable to pump a nutrient solution or other fluid from the reservoir to the shelf, the light sources are configured to selectively light areas above the shelf, and the plant rafts are positionable atop the nutrient solution or other fluid in the reservoir, wherein plants may be grown on the plant rafts or on the shelf above.

### (h) BRIEF SUMMARY OF THE INVENTION

An embodiment of the disclosure meets the needs presented above by generally comprising a reservoir with a bottom wall and a perimeter wall, the perimeter wall being coupled to and extending away from the bottom wall. The reservoir has a cavity which is defined by the bottom wall and the perimeter wall and which is open at a top end of the reservoir. A shelf is coupled to and spaced upwardly from the reservoir. The shelf has a base wall and a peripheral wall, the peripheral wall being coupled to and extending away from the base wall. The shelf has a recess defined by the base wall and the peripheral wall. A fluid circulation mechanism is coupled to the reservoir and the shelf. The fluid circulation mechanism comprises a delivery line extending from the cavity of the reservoir to the recess of the shelf, a pump mounted to the delivery line, and a return line extending from the recess of the shelf to the cavity of the reservoir. The pump is operable to urge a nutrient fluid from the cavity of the reservoir to the recess of the shelf via the delivery line, and the nutrient fluid is allowed to pass through the return line after circulating in the recess of the shelf.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a plant growing system according to an embodiment of the disclosure.

FIG. 2 is a front view of an embodiment of the disclosure.

FIG. 3 is a side view of an embodiment of the disclosure.

FIG. 4 is a detail view of an embodiment of the disclosure taken from Window 4 in FIG. 2.

FIG. 5 is a detail view of an embodiment of the disclosure taken from Window 5 in FIG. 2.

FIG. 6 is a block diagram of an embodiment of the disclosure.

### (j) DETAILED DESCRIPTION OF THE INVENTION

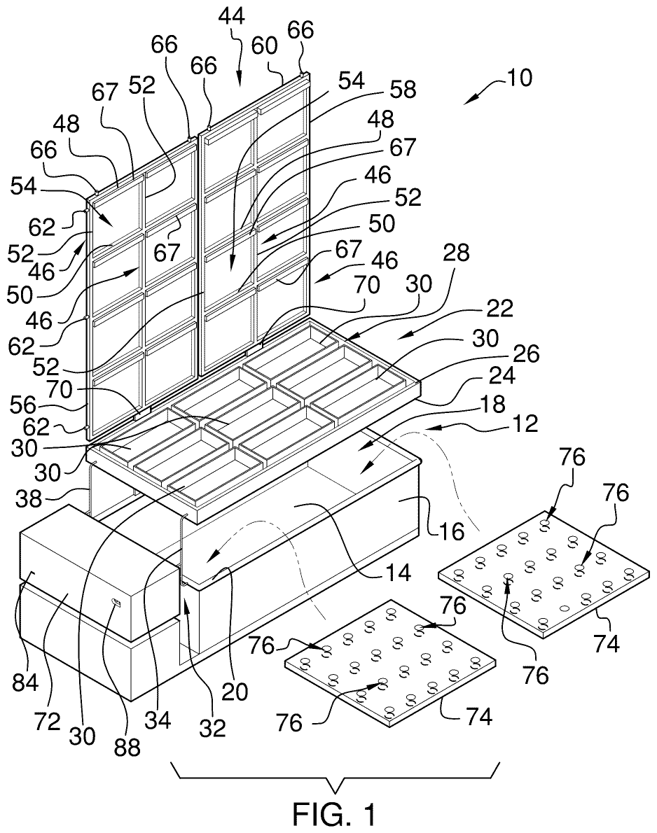

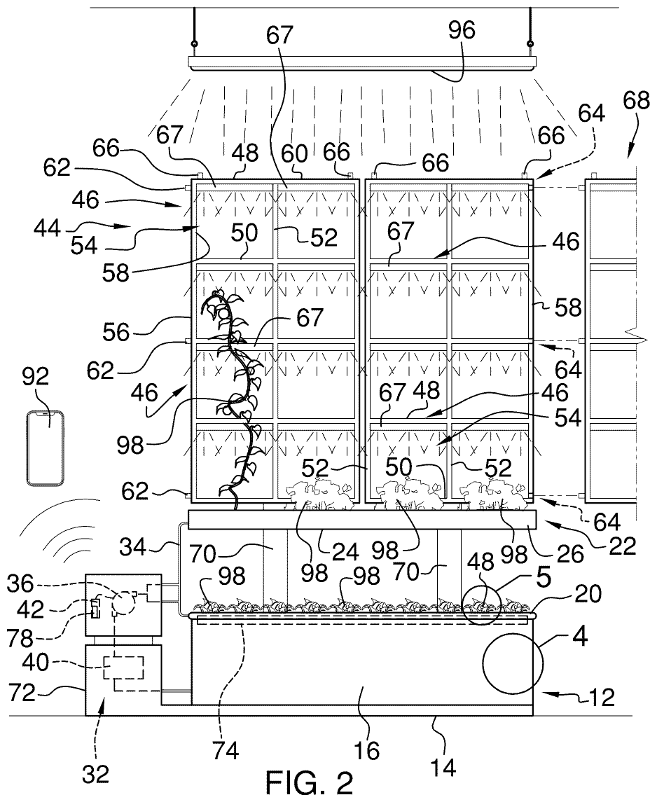

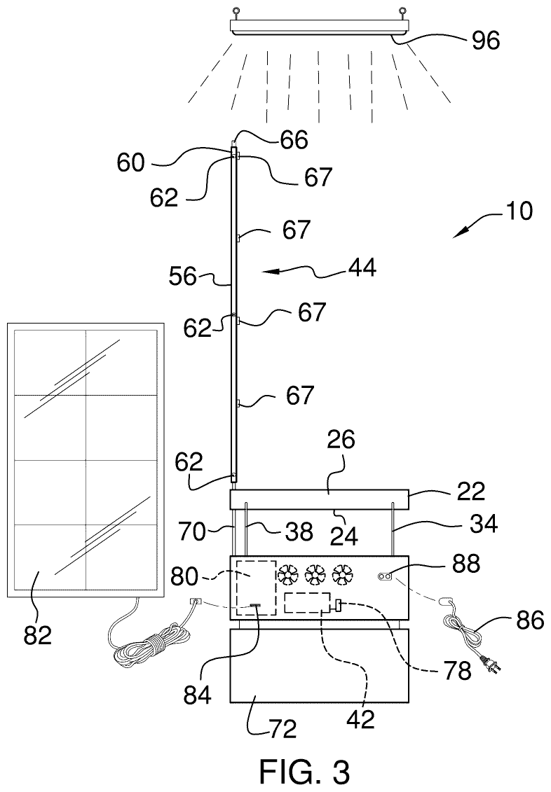

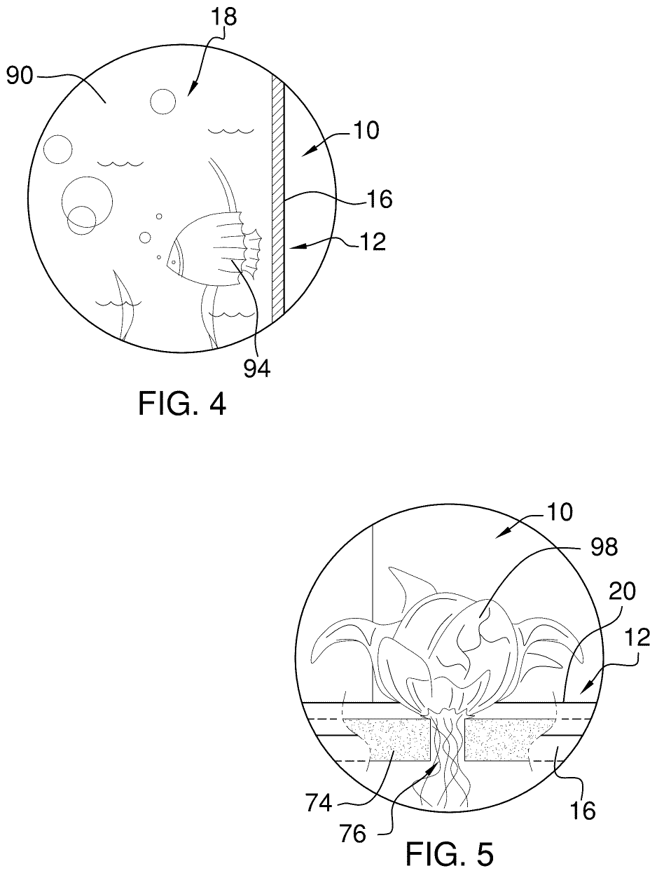

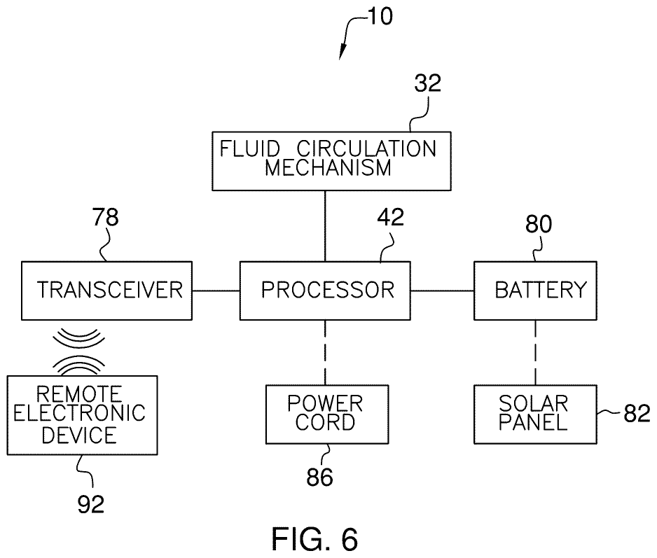

With reference now to the drawings, and in particular to FIGS. 1 through 6 thereof, a new plant growing system embodying the principles and concepts of an embodiment of the disclosure and generally designated by the reference numeral 10 will be described.

As best illustrated in FIGS. 1 through 6, the plant growing system 10 generally comprises a reservoir 12 with a bottom wall 14 and a perimeter wall 16. The perimeter wall 16 is coupled to and extends away from the bottom wall 14. The reservoir 12 has a cavity 18 which is defined by the bottom wall 14 and the perimeter wall 16 and which is open at a top end 20 of the reservoir 12. The reservoir 12 may be filled with a nutrient fluid 90, which is broadly defined to include mineral nutrient solutions or other suitable fluids intermixed with nutrients beneficial to growing plants in a hydroponic process. The nutrient fluid 90 may also include water in which aquatic animals 94 such as fish, crayfish, snails, or prawns are raised, which becomes rich in nutrients beneficial to plant growth due to expelling substances considered waste to the aquatic animals 94.

A shelf 22 is coupled to and spaced upwardly from the reservoir 12. The shelf 22 has a base wall 24 and a peripheral wall 26, wherein the peripheral wall 26 is coupled to and extends away from the base wall 24. The shelf 22 has a recess 28 defined by the base wall 24 and the peripheral wall 26. A plurality of trays 30 is coupled to the shelf 22 and is positioned in the recess 28 of the shelf 22.

A fluid circulation mechanism 32 is coupled to the reservoir 12 and the shelf 22. The fluid circulation mechanism 32 comprises a delivery line 34 which extends from the cavity 18 of the reservoir 12 to the recess 28 of the shelf 22, a pump 36 mounted to the delivery line 34, and a return line 38 which extends from the recess 28 of the shelf 22 to the cavity 18 of the reservoir 12. The pump 36 is operable to urge the nutrient fluid 90 from the cavity 18 of the reservoir 12 to the recess 28 of the shelf 22 via the delivery line 34, which circulates within the recess 28 of the shelf 22 until it drains through the return line 38 back to the cavity 18 of the reservoir 12. The nutrient fluid 90 further comprises a filtration device 40 which is mounted on the delivery line 34 between the reservoir 12 and the pump 36. The filtration device 40 filters undesirable substances from the nutrient fluid 90. Undesirable substances may, for example, include solid particulates of a size and composition that may not be used by plants growing on the shelf 22 or may cause damage to the pump 36. Chemical processes may also be used to remove undesirable substances from the nutrient fluid 90 and various known filtration methods beyond simple barrier filtration may be used.

A processor 42 is operatively coupled to the pump 36 of the fluid circulation mechanism 32 and may be operatively coupled to the filtration device 40 in embodiments where the filtration device 40 includes mechanisms that may be controlled by the processor 42. The processor 42 comprises an artificial intelligence module such that the processor 42 is designed to reason, plan, learn, or perform other operations related to artificial intelligence.

A framework 44 is coupled to and extends upwardly from the peripheral wall 26 of the shelf 22. The framework 44 comprises a plurality of frame cells 46, each frame cell 46 of the plurality of frame cells 46 having an opening 54 extending through the frame cell 46. The framework 44 may support vining plants or the like which weave through the plurality of frame cells 46. Each frame cell 46 comprises a top member 48, a bottom member 50, and a pair of side members 52, wherein the top member 48 and the bottom member 50 of each frame cell 46 are positioned opposite each other across the pair of side members 52. The side members 52 of each frame cell 46 are also oriented perpendicularly to the top member 48 and the bottom member 50 of the frame cell 46. A plurality of lamps 67 is coupled to the framework 44, wherein each lamp 67 is mounted to the top member 48 of an associated frame cell 46 of the plurality of frame cells 46.

Each lamp 67 is operatively coupled to the processor 42 via wiring (not shown) but may be wirelessly coupled in some embodiments.

The framework 44 may be expanded by adding additional frameworks 68 to mount to the framework 44. A connection assembly facilitates such expansion, wherein mating components of the connection assembly on the framework 44 connect to mating components of connection assemblies on the additional frameworks 68. The connection assembly of the framework 44 includes a plurality of first lateral connection members 62 coupled to a first lateral side 56 of the framework 44, a plurality of second lateral connection members 64 coupled to a second lateral side 58 of the framework 44, and a plurality of top connection members 66 coupled to a top side 60 of the framework 44.

Each first lateral connection member 62 comprises an insertion member which interchangeably connects to receivers of the additional frameworks 68. Each second lateral connection member 64 comprises a receiver which interchangeably connects to insertion members of the additional frameworks 68. Each top connection member 66 comprises an insertion member which interchangeably connects to receivers of the additional frameworks 68.

A pair of posts 70 are coupled to a rear side of the perimeter wall 16 of the reservoir 12 and extend upwardly therefrom. The shelf 22 and the framework 44 are mounted onto the pair of posts 70 such that they are positioned as described above and depicted in the Figures. A housing 72 mounted to a side of the reservoir 12 contains the processor 42 and the fluid circulation mechanism 32 (except for portions of the delivery line 34 and the return line 38).

The insertion members of the first lateral connection members 62 and the top connection members 66 are equivalent in structure to each other and have a complementary structure to the receivers of the second lateral connection members 64. The insertion members of the additional frameworks 68 and the receivers of the additional frameworks 68 are also equivalent in structure to the insertion members of the framework 44 and the receivers of the framework 44 respectively. The additional frameworks 68 may have insertion members on their first lateral sides, receivers on their second lateral sides, insertion members on their top sides, and receivers on their bottom sides. In this manner, the framework 44 may be continually expanded upwardly and laterally from the framework 44 by the addition of a select number of additional frameworks 68 in any of these directions.

A pair of plant rafts 74 is provided, wherein each plant raft 74 has a buoyancy sufficient to float atop the nutrient fluid 90 in the cavity 18 of the reservoir 12 and support plants thereon. Each plant raft 74 has a plurality of holes 76 which extends therethrough to permit plants to be inserted into the holes 76 to contact the nutrient fluid 90 while being seated atop the plant raft 74. Lettuce is a plant which has been typically grown this way, but any plant which benefits from growing on such a raft may be grown in this manner.

A transceiver 78 is operatively coupled to the processor 42 and mounted in the housing 72, which is configured to wirelessly communicate with a remote electronic device 92 via the transceiver 78. The remote electronic device 92 may be a mobile phone, a tablet, a laptop or desktop computer, or any other suitable computing device. The processor 42 may receive commands via the remote electronic device 92 for operating the fluid circulation mechanism 32, the filtration device 40, and the lamps 67. Additional light sources 96 or other devices which affect growth of plants grown on the plant growing system 10 may be mounted in other locations on or around the reservoir 12, the shelf 22, the framework 44, the additional frameworks 68, and other similar locations and may communicate with the processor 42 through wired or wireless means such that the processor 42 may operate them. The artificial intelligence module of the processor 42 may also receive input via the remote electronic device 92 which causes the artificial intelligence module to reason, learn, or otherwise develop different operational processes for the fluid circulation mechanism 32, the filtration device 40, the lamps 67, and other controllable components operatively coupled to the processor 42.

The processor 42 is powered by a battery 80 which is electrically coupled to the processor 42 and mounted in the housing 72. The battery 80 may also power some or all of the fluid circulation device, the filtration device 40, the lamps 67, and other electronic components, and the processor 42 may determine when power is delivered from the battery 80 to these destinations. A solar panel 82 is electrically couplable to the battery 80 via a solar panel electrical port 84. The processor 42 is also couplable to an external power supply such as a utility power supply, a generator, or the like via a power cord 86 which is couplable to the processor 42 via an electrical cord port 88.

In use, the plant growing system 10 is used to grow plants 98 hydroponically and grow aquatic animals 94 in the reservoir 12. The aquatic animals 94 may benefit at least some of the plants 98 by expelling substances into the nutrient fluid 90 contained in the reservoir 12 as described above. Different plants 98 may be grown on the plant rafts 74, the trays 30 of the shelf 22, and the framework 44, depending on their structure and nutrient needs as understood by those knowledgeable in the art of hydroponics and related horticultural practices.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A plant growing system comprising:
a reservoir comprising a bottom wall and a perimeter wall, the perimeter wall being coupled to and extending away from the bottom wall, the reservoir having a cavity defined by the bottom wall and the perimeter wall, the cavity being open at a top end of the reservoir;
a shelf coupled to and spaced upwardly from the reservoir, the shelf having a base wall and a peripheral wall, the peripheral wall being coupled to and extending away from the base wall, the shelf having a recess defined by the base wall and the peripheral wall;
a fluid circulation mechanism coupled to the reservoir and the shelf, the fluid circulation mechanism comprising:
a delivery line extending from the cavity of the reservoir to the recess of the shelf;
a pump mounted to the delivery line, the pump being operable to urge a nutrient fluid from the cavity of the reservoir to the recess of the shelf via the delivery line; and
a return line extending from the recess of the shelf to the cavity of the reservoir, the return line facilitating drainage of the nutrient fluid from the recess of the shelf to the cavity of the reservoir;
a framework coupled to and extending upwardly from the peripheral wall of the shelf, the framework comprising a plurality of frame cells, each frame cell of the plurality of frame cells having an opening extending therethrough; and
a plurality of lamps coupled to the framework, each lamp of the plurality of lamps being operatively coupled to the processor, each lamp of the plurality of lamps being mounted to an associated frame cell of the plurality of frame cells such that each lamp is positioned extending along and adjacent to a top member of the associated frame cell.

2. The plant growing system of claim 1, wherein the fluid circulation mechanism further comprises a filtration device mounted on the delivery line between the reservoir and the pump, the filtration device being configured to filter undesirable substances from the nutrient fluid.

3. The plant growing system of claim 1, further comprising a plurality of trays coupled to the shelf, the plurality of trays being positioned in the recess of the shelf.

4. The plant growing system of claim 1, further comprising a processor operatively coupled to the pump of the fluid circulation mechanism.

5. The plant growing system of claim 4, wherein the processor comprises an artificial intelligence module.

6. The plant growing system of claim 4, further comprising a transceiver operatively coupled to the processor, the processor being configured to wirelessly communicate with a remote electronic device via the transceiver.

7. The plant growing system of claim 4, further comprising a battery electrically coupled to the processor.

8. The plant growing system of claim 7, further comprising a solar panel electrically couplable to the battery.

9. The plant growing system of claim 4, further comprising a power cord electrically couplable to the processor and to an external power supply.

10. (canceled)

11. The plant growing system of claim 1, wherein each frame cell of the plurality of frame cells comprises the top member, a bottom member, and a pair of side members, the top member and the bottom member of each frame cell being positioned opposite each other across the pair of side members, the pair of side members of each frame cell being oriented perpendicularly to the top member and the bottom member of the frame cell.

12. (canceled)

13. The plant growing system of claim 1, further comprising a connection assembly coupled to the framework for attaching additional frameworks to the framework.

14. The plant growing system of claim 13, wherein the connection assembly comprises a plurality of first lateral connection members coupled to a first lateral side of the framework, a plurality of second lateral connection members coupled to a second lateral side of the framework, and a plurality of top connection members coupled to a top side of the framework, each first lateral connection member of the plurality of first lateral connection members comprising an insertion member, each second lateral connection member of the plurality of second lateral connection members comprising a receiver, each top connection member of the plurality of top connection members comprising an insertion member.

15. The plant growing system of claim 1, further comprising a plant raft which has a buoyancy sufficient to float atop the nutrient fluid in the cavity of the reservoir, the plant raft having a plurality of holes extending therethrough to permit plants to be inserted into the holes to contact the nutrient fluid while being seated atop the plant raft.

16. A plant growing system comprising:
a reservoir comprising a bottom wall and a perimeter wall, the perimeter wall being coupled to and extending away from the bottom wall, the reservoir having a cavity defined by the bottom wall and the perimeter wall, the cavity being open at a top end of the reservoir;
a shelf coupled to and spaced upwardly from the reservoir, the shelf having a base wall and a peripheral wall, the peripheral wall being coupled to and extending away from the base wall, the shelf having a recess defined by the base wall and the peripheral wall;
a plurality of trays coupled to the shelf, the plurality of trays being positioned in the recess of the shelf;
a fluid circulation mechanism coupled to the reservoir and the shelf, the fluid circulation mechanism comprising:
a delivery line extending from the cavity of the reservoir to the recess of the shelf;
a pump mounted to the delivery line, the pump being operable to urge a nutrient fluid from the cavity of the reservoir to the recess of the shelf via the delivery line;
a return line extending from the recess of the shelf to the cavity of the reservoir, the return line facilitating drainage of the nutrient fluid from the recess of the shelf to the cavity of the reservoir; and
a filtration device mounted on the delivery line between the reservoir and the pump, the filtration device being configured to filter undesirable substances from the nutrient fluid;
a processor operatively coupled to the pump of the fluid circulation mechanism, the processor comprising an artificial intelligence module;
a framework coupled to and extending upwardly from the peripheral wall of the shelf, the framework comprising a plurality of frame cells, each frame cell of the plurality of frame cells having an opening extending therethrough, each frame cell of the plurality of frame cells comprising a top member, a bottom member, and a pair of side members, the top member and the bottom member of each frame cell being positioned opposite each other across the pair of side members, the pair of side members of each frame cell being oriented perpendicularly to the top member and the bottom member of the frame cell;
a plurality of lamps coupled to the framework, each lamp of the plurality of lamps being operatively coupled to the processor, each lamp of the plurality of lamps being mounted to an associated frame cell of the plurality of frame cells, each lamp of the plurality of lamps being positioned on the top member of the associated frame cell;
a connection assembly coupled to the framework for attaching additional frameworks to the framework, the connection assembly comprising a plurality of first lateral connection members coupled to a first lateral side of the framework, a plurality of second lateral connection members coupled to a second lateral side of the framework, and a plurality of top connection members coupled to a top side of the framework, each first lateral connection member of the plurality of first lateral connection members comprising an insertion member, each second lateral connection member of the plurality of second lateral connection members comprising a receiver, each top connection member of the plurality of top connection members comprising an insertion member;
a pair of plant rafts, each plant raft of the pair of plant rafts having a buoyancy sufficient to float atop the nutrient fluid in the cavity of the reservoir, each plant raft having a plurality of holes extending therethrough to permit plants to be inserted into the holes to contact the nutrient fluid while being seated atop the plant raft;
a transceiver operatively coupled to the processor, the processor being configured to wirelessly communicate with a remote electronic device via the transceiver;
a battery electrically coupled to the processor;
a solar panel electrically couplable to the battery; and
a power cord electrically couplable to the processor and to an external power supply.
